(19) United States
(12) Patent Application Publication
(10) Pub. No.: US 2005/0245337 A1
(43) Pub. Date: Nov. 3, 2005

(54) Power transmission device

(75) Inventors: Hiroaki Matsuyama, Isesaki-shi (JP); Atsushi Ozawa, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/116,455

(22) Filed: Apr. 28, 2005

(30) Foreign Application Priority Data
Apr. 30, 2004 (JP) 2004/136374

(51) Int. Cl. F16G 5/16; F16H 9/00; F16G 1/21

(52) U.S. Cl. 474/199; 474/70

(57) ABSTRACT

A power transmission device has a driving pulley disposed in a power transmitting path between a vehicle engine and a compressor for an air conditioning system of the vehicle and is rotatably supported on the compressor, and a driven rotor arranged in the driving pulley, for connecting between the driving pulley and a drive shaft of the compressor. The driven rotor has an outer ring forming its outer circumferential surface, a plurality of connecting lugs integrally formed in the outer ring, for fastening the outer ring to one end face of the driving pulley with connecting bolts, and a hardened layer formed in the entire surfaces of the connecting lugs by heat treatment.

This Nonprovisional application claims priority under 35 U.S.C. § 119(a) on Patent Application No. 2004-136374 filed in Japan on Apr. 30, 2004, the entire contents of which-are-hereby incorporated-by reference.

### BACKGROUND OF THE INVENTION

1. Field of the Invention

The present invention relates to a power transmission device, for example, for transmitting power from an engine of a vehicle to a compressor of an air conditioning system for the vehicle.

2. Description of the Related Art

A power transmission device of this type is disclosed in, for example, Unexamined Japanese Patent Publication No. 2001-153152. This well-known device includes a driving member, namely a driving pulley, which receives power from an engine of a vehicle and is rotated by the received power, and a driven member, namely a driven rotor, which connects the driving pulley and the drive shaft of a compressor. The driven rotor has a torque limiter built-in. When a torque load of the driving pulley is equal to the prescribed value or less, the torque limiter transmits the torque of the driving pulley to the driven rotor, that is, to the drive shaft of the compressor. If the torque load of the driving pulley exceeds the prescribed value, however, the torque limiter breaks the torque transmission to the driven rotor so that the driving pulley idles.

Specifically, the driven rotor is concentrically arranged in the driving pulley and includes an outer ring in its outer circumference. The outer ring has a flange in its outer circumferential surface, and the flange protrudes from the outer ring in a radial outward direction. The flange is connected to one end face of the driving pulley with a plurality of connecting bolts in the state superposed upon the one end face. These connecting bolts are arranged at regular intervals in the circumferential direction of the outer ring and clamp the flange between their heads and the one end face of the driving pulley. As a result, the torque of the driving pulley is firstly transmitted to the driven rotor, namely the outer ring.

Considering the productivity and production cost of the outer ring, the outer ring is preferably formed from a rolled steel plate by press working. The press working makes it possible to form the outer ring and the flange at the same time.

However, the rolled steel plate allows press forming, so that the rolled steel plate has relatively low hardness. Meanwhile, the speed of the engine drastically fluctuates according to the running condition of the vehicle. Therefore, repeated loads attributable to the fluctuation of the speed of the engine are transmitted through the driving pulley to the outer ring of the driven rotor. When such repeated loads are applied to the outer ring over a long period of time, the flange of the outer ring is deformed in its seat portions with respect to the heads of the connecting bolts in the axis direction, or clamping direction, of the connecting bolts.

The deformation of the flange deteriorates the clamping force of the connecting bolts, and thus causes the outer ring to rattle on the driving pulley. Consequently, there generates vibration and noises of the power transmission device, and the power transmission device cannot transmit the power of the engine to the compressor satisfactorily and stably.

Metal parts included in the driving pulley and the driven rotor are coated to maintain their appearance quality. The flange of the outer ring is also coated in its outer surface. The coating is softer than the rolled steel plate serving as a base material of the outer ring, and is liable to get soft when ambient temperature is increased.

As a consequence, when the repeated loads are applied to the flange of the outer ring over a long period of time, the coating covering the seat portions of the flange and the coating of the flange in close contact with the one end face of the driving pulley are prone to be abraded even though the flange is not deformed. Such abrasion of the coating, as well as the deformation of the flange, weakens the clamping force of the connecting bolts.

### SUMMARY OF THE INVENTION

An object of the present invention is to provide a power transmission device capable of stably connecting a driving member and a driven member over a long period of time and satisfactorily transmitting power from the driving member to the driven member.

To achieve the above object, the power transmission device of the present invention is used for transmitting power of a drive source to a consumption device. The power transmission device comprises a ring-shaped driving member for receiving power of the drive source to be rotated by the received motive power, the driving member having one end face and a screw hole formed in the one end face; a cylindrical driven member concentrically arranged in the driving member, for connecting the driving member and a drive shaft of the consumption device, the driven member including an outer circumferential surface, a metal connecting element protruded from the outer circumferential surface in a radial outward direction of the driven member and superposed upon the one end face of the driving member, and a bolt passed through the connecting element to be screwed into the screw hole of the driving member, for connecting the connecting element to the one end face of the driving member; and a retaining mechanism for retaining a clamping force of the bolt, the mechanism including a treatment portion provided to at least one of the connecting element and the driving member.

More specifically, the power transmission device comprises a driving pulley disposed in a power transmitting path connecting the engine of a vehicle serving as the drive source and a compressor, as the consumption device, of an air conditioning system of the vehicle, the driving pulley being rotatably supported on a housing of the compressor as the driving member. The driven member is a driven rotor having a torque limiter built-in.

In this case, the driven rotor further may include a center disc connected to the drive shaft of the compressor, and a ring-shaped absorptive rubber for enclosing the center disc. The absorptive rubber has an inner ring engaged with the center disc with the torque limiter intervening therebetween, and an outer ring for forming the outer circumferential surface of the driven rotor, the outer ring being provided with the connecting element.

The connecting element may include a plurality of lugs integrally formed in the outer ring. The lugs are arranged at regular intervals in a circumferential direction of the outer ring and protrude in a radial outward direction of the outer ring.

The treatment portion of the retaining mechanism may include a heat treatment layer formed in an entire surface of the connecting element or entire surfaces of the lugs. In this case, the heat treatment layer is a hardened layer. Such a hardened layer prevents deformation of the connecting element or lugs, which is caused by the repeated loads, and allows the clamping force of the bolt to be stably retained over a long period of time.

The treatment portion of the retaining mechanism may include coating formed on the connecting element or lugs, except for at least a seat portion of the connecting element or that of a lug with respect to the bolt.

In the above-described case, since the seat portion of the connecting element or the lugs do not have coating, the connecting element or lugs do not have the problem itself that the clamping force of the bolt is decreased due to abrasion of the coating.

The treatment portion of the retaining mechanism may include a machined portion formed in the driving member or driving pulley. The machined portion allows at least one of the bolt and part of the driving member or driving pulley to be elastically deformed in an axis direction of the bolt.

More specifically, the machined portion includes a clearance hole opened in the one end face of the driving member or driving pulley so that the clearance hole is connected to the screw hole. The clearance hole has an inner diameter larger than an outer diameter of the bolt. In this case, the clearance hole allows the bolt to be elastically deformed in the axis direction of the bolt when the bolt is screwed the screw hole.

The machined portion further may further include an annular groove formed in an inner circumferential surface of the driving member or driving pulley. The annular groove separates the clearance hole from the bolt hole and forms a thin wall in the driving member or driving pulley, the thin wall including the one end face of the driving member or driving pulley and being elastically deformable in the axis direction of the bolt.

The elastic deformation of the bolt itself or of the thin wall prevents the deformation of the seat portion of the connecting element or the lugs and/or the abrasion of the coating, caused by the repeated loads, thus stably retaining the clamping force of the bolt over a long period of time.

As a consequence, the power transmission device of the present invention is capable of satisfactorily transmitting the power of the drive source (engine) to the consumption device (compressor) without generating vibration and noises from the driven member (driven rotor).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirits and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a sectional view showing a power transmission device applied to a compressor for an air conditioning system of a vehicle;

FIG. 2 is a sectional view, taken along line II-II of FIG. 1;

FIG. 3 is a view from the direction of an arrow III of FIG. 1;

FIG. 4 is a view showing a retaining mechanism of a first embodiment;

FIG. 5 is a view showing the device of FIG. 1 in a state where a torque limiter is activated;

FIGS. 6 and 7 are views showing a retaining mechanism of a second embodiment;

FIG. 8 is a view showing a retaining mechanism of a third embodiment; and

FIG. 9 is a view showing a retaining mechanism of a fourth embodiment.

### DETAILED DESCRIPTION OF THE PREFERRED EMBODIMENTS

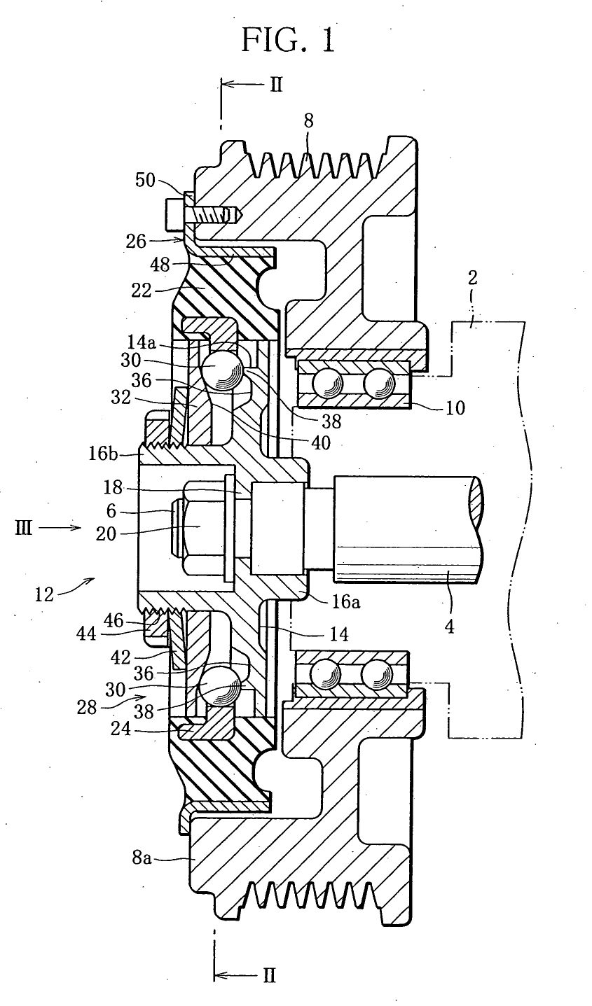

A power transmission device shown in FIG. 1 is used for an air conditioning system of a vehicle and transmits power from an engine of the vehicle, not shown, to a compressor 2 of the air conditioning system. To this end, a drive shaft 4 of the compressor 2 has one end 6 protruding from a housing of the compressor 2.

The power transmission device is provided with a driving pulley 8 serving as a driving member. The driving pulley 8 is concentrically disposed outside the drive shaft 4 and is rotatably supported on the housing of the compressor 2 with a bearing 10 intervening therebetween. The driving pulley 8 is connected to an output pulley of the engine through a drive belt. Therefore, when the power from the engine is transmitted through the drive belt to the driving pulley 8, the driving pulley 8 is rotated in one direction.

The driving pulley 8 is provided with coating in an entire surface thereof. The coating prevents rust from emerging in the entire surface of the driving pulley 8 even after long-term use of the driving pulley 8. In FIG. 1, the output pulley, the drive belt, and the coating of the driving pulley 8 are not shown.

The driving pulley 8 is connected to the drive shaft 4 through a driven rotor 12 serving as a driven member. The driven rotor 12 will be described below in detail.

The driven rotor 12 is concentrically arranged in the driving pulley 8 and is provided with a circular center disc 14. The center disc 14 is made of metal and includes a hub at the center. The hub has an inner boss 16a protruding from an inner end face of the center disc 14 toward the compressor 2 and an outer boss 16b protruding from an outer end face of the center disc 14. The bosses 16a and 16b are partitioned by a wall 18.

The one end 6 of the drive shaft 4 passes through the partition wall 18 from the side of the inner boss 16a and is located in the outer boss 16b. The one end 6 of the drive shaft 4 has a male thread, with which a nut 20 is engaged. The nut 20 clamps the one end 6 of the drive shaft 4 onto the partition wall 18, thus fixing the center disc 14 to the drive shaft 4.

The center disc 14 is enclosed by a ring-shaped absorptive rubber 22, which has an inner ring 24 and an outer ring 26 forming an inner circumferential surface and an outer circumferential surface thereof, respectively. The inner ring 24 and the outer ring 26 are both made of metal and are each bonded to the absorptive rubber 22 by vulcanizing the absorptive rubber 22.

The inner ring 24 is connected to the center disc 14 with a torque limiter 28 intervening therebetween. The torque limiter 28 includes a plurality of balls 30 made of metal. The balls 30 are clamped among the inner ring 24, the center ring 14 and a pressure disc 32.

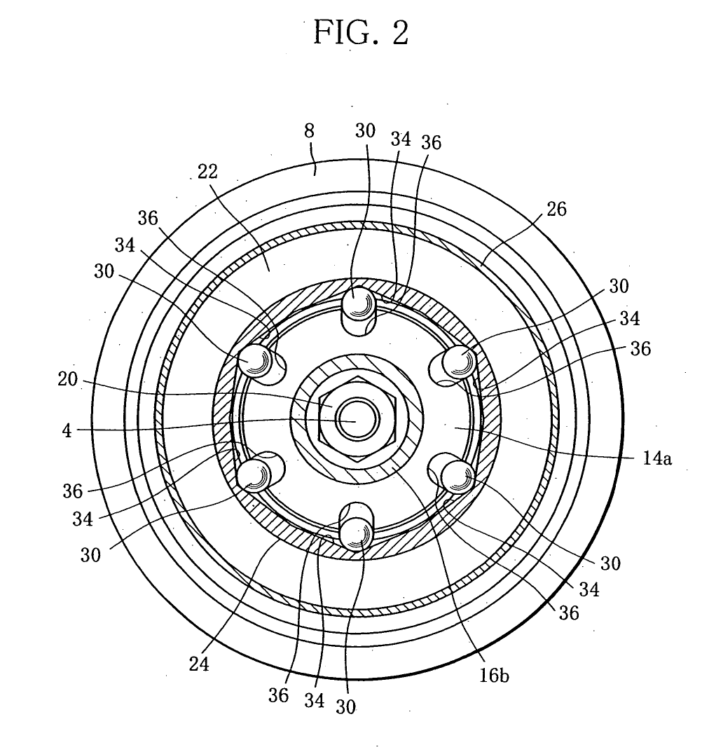

More specifically, the inner ring 24 protrudes from the inner circumferential surface of the absorptive rubber 22 and has an inner face directed toward a radial inward direction of the absorptive rubber 22. As is clear from FIG. 2, the inner face of the inner ring 24 is formed of a plurality of recessed faces, or a plurality of V-shaped surfaces 34, which range in the circumferential direction of the inner ring 24. The balls 30 are located at bottoms of the respective V-shaped surfaces 34 so that the balls 30 are each pinched between two sides forming the respective V-shaped surfaces 34.

An outer circumferential edge of the center disc 14 has a stepped shape. The center disc 14 includes a large-diameter portion located on the inner boss 16a side and a small-diameter portion 14a on the outer boss 16b side. A plurality of radial grooves 36 are formed in an outer circumferential portion of the end face of the small-diameter portion 14a so as to correspond to the number of the balls 30. The radial grooves 36 are arranged at regular intervals in the circumferential direction of the center disc 14. The radial grooves 36 are each formed to have the shape of a U which is capable of receiving the corresponding ball 30, and open in the outer circumferential edge of the small-diameter portion 14a.

As is apparent from FIG. 1, there is formed a resting seat 38 in an opening edge of each radial grooves 36. The resting seat 38 is formed into the shape of a circular arc that fits to the ball 30. The resting seats 38 protrude toward the inside of the radial grooves holes 36, thereby reducing the depth of the radial grooves holes 36 at the opening edges thereof.

The pressure disc 32 is mounted on an outer circumferential surface of the outer boss 16b of the center disc 14 and is movable in an axis direction of the outer boss 16b. The pressure disc 32 has an inner end face directed toward the center disc 14, and a ring-shaped tapered surface 40 is formed in an outer circumferential portion of the inner end face. The tapered surface 40 is a convex surface which protrudes toward the center disc 14 and has a maximum outer diameter that is substantially the same as an outer diameter of the small-diameter portion 14a of the center disc 14.

Mounted on the outer circumferential surface of the outer boss 16b is a dish spring 42 to be located outside the pressure disc 32. The dish spring 42 is sandwiched between the pressure disc 32 and a nut 44, thus urging the pressure disc 32 to the resting seat 38 side, that is, to the center disc 14 side. The nut 44 is screwed on a male thread 46 formed in the outer end portion of the outer boss 16b.

In a condition illustrated in FIG. 1, each ball 30 is clamped between the resting seat 38 of the corresponding radial groove 36 and the outer circumferential edge portion of the tapered surface 40 of the pressure disc 32 in a state the ball 30 is located at the bottom of the V-shaped surface 34. Each ball 30 is pressed against both the V-shaped surface 34 and the resting seat 38 by the tapered surface 40 due to the urging force. In other words, the tapered surface 40 presses the balls 30 both in the radial outward direction and in the axis direction of the center disc 14. Therefore, the balls 30 are prevented from falling into the radial grooves 36.

The retention force of the balls 30 is determined by urging force of the dish spring 42. The urging force of the dish spring 42 is adjustable by changing a screw stroke of the nut 44 with respect to the outer boss 16b.

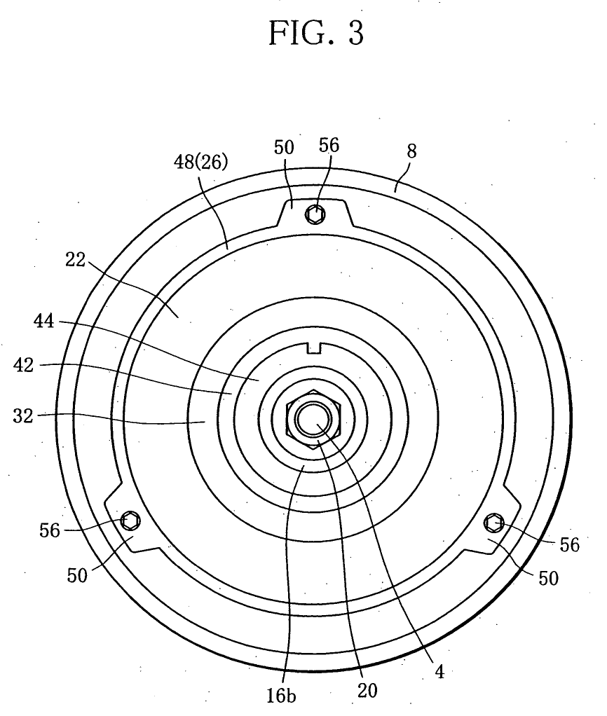

As is obvious from FIG. 1, the outer ring 26 includes a cylindrical portion 48, which covers the outer circumferential surface of the absorptive rubber 22 and is attached to the outer circumferential surface. The cylindrical portion 48 has for example three connecting lugs 50 that are integrally formed on an outer edge of the cylindrical portion 48. As is evident from FIG. 3, the connecting lugs 50 are arranged at regular intervals in a circumferential direction of the outer ring 26 and protrude in the radial outward direction of the outer ring 26.

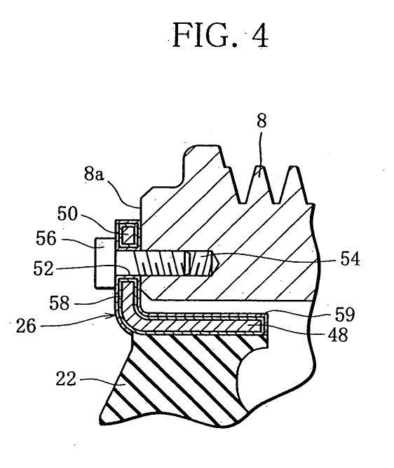

As illustrated in FIG. 4, each connecting lug 50 has a through-hole 52, and screw holes 54 are formed in the one end face 8a of the driving pulley 8 to correspond to the respective connecting lugs 50. Each connecting lug 50 is fastened to the driving pulley 8 with a connecting bolt 56 in a state where the corresponding through-hole 52 is aligned with the screw hole 54 of the driving pulley 8 and superposed upon the one end face 8a of the driving pulley 8. In other words, the connecting bolts 56 are screwed in the respective screw holes 54 from the one end face 8a side of the driving pulley 8 through the through-holes 52 of the connecting lugs 50.

Consequently, as is apparent from the above explanation, the driven rotor 12 is connected to the driving pulley 8 through the outer ring 26 of the absorptive rubber 22 and is simultaneously connected to the drive shaft 4 through the center disc 14. Furthermore, the driven rotor 12 has the torque limiter 28 built-in, which connects the center disc 14 and the inner ring 24 of the absorptive rubber 22.

For additional explanations on the outer ring 26, the outer ring 26 is integrally formed with the connecting lugs 50 by subjecting a rolled steel plate, such as a cold rolled steel plate, to press working. After being formed, the outer ring 26 is subjected to a heat treatment, such as a gas nitriding treatment, over an entire surface thereof. The heat treatment produces a hardened layer 58 on the entire surface of the outer ring 26. The hardened layer 58 increases the hardness of the outer ring 26. Moreover, the hardened layer 58 of the outer ring 26 is covered with coating 59, except for a portion to be bonded to the absorptive rubber 22, that is, the inner circumferential surface of the cylindrical portion 48. Therefore, even if the driven rotor 12, or the outer ring 26, is used over a long period of time, rust does not emerge on the outer ring 26.

With the above-described power transmission device, when the power of the engine is supplied to the driving pulley 8, the driving pulley 8 is rotated together with the outer ring 26 of the driven rotor 12. Torque of the outer ring 26 is transmitted through the absorptive rubber 22 to the inner ring 24, thus causing the inner ring 24 to rotate. At this moment, even if fluctuation in engine speed is transmitted to the driving pulley 8, the fluctuation of the rotation of the driving pulley 8 is absorbed by the absorptive rubber 22 due to elastic deformation of the absorptive rubber 22.

Torque of the inner ring 24 is transmitted through the torque limiter 28 to the center disc 14, thus causing the center disc 14, or the drive shaft 4 of the compressor 2, to rotate. To be more specific, the torque of the inner ring 24 is transmitted from the V-shaped surfaces 34 of the inner ring 24 to the balls 30, and the balls 30 push the resting seats 38 of the respective radial grooves 36 in the circumferential direction of the center disc 14. As a result, the center disc 14 is rotated together with the inner ring 24, thereby causing the drive shaft 4 of the compressor 2 to rotate.

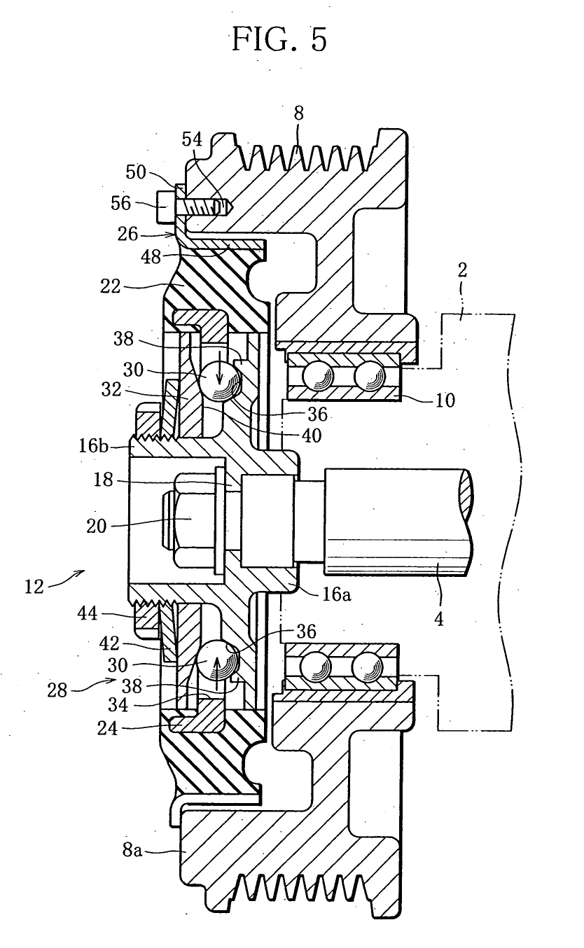

For example, when seizure or the like occurs in the compressor 2, and rotational speed of the drive shaft 4 is reduced to a prescribed level to be less than that of the driving pulley 8, the torque to be transmitted from the inner ring 24 to the center disc 14 becomes so excessive as to overcome the retention force of the balls 30. In this case, the V-shaped surfaces 34 of the inner ring 24 push the balls 30 in the radial inward direction of the center disc 14 against the urging force of the tapered surface 40 of the pressure disc 32, namely the dish spring 42. Therefore, the balls 30 leave the respective resting seats 38 of the radial grooves 36, and as illustrated in FIG. 5, fall into the radial grooves 36. This disengages the V-shaped surfaces 34 of the inner ring 24 from the balls 30. As a result, the transmission of the power from the inner ring 24 to the center disc 14 is broken, and the driving pulley 8 idles.

The outer ring 26 of the driven rotor 12 is applied with repeated loads due to the fluctuation of the engine speed over a long period of time. The power transmission device, however, has the retaining mechanism of the first embodiment, and the retaining mechanism prevents a clamping force of the connecting bolts 56 from being reduced.

More specifically, the retaining mechanism of the first embodiment includes the hardened layer 58 formed in the entire surface of the outer ring 26 including the connecting lugs 50. The hardened layer 58 prevents seat portions of the connecting lugs 50 with respect to heads of the connecting bolts 56 from being deformed in an axis direction, or in a clamping direction, of the connecting bolts 56, when the outer ring 26 or the connecting lugs 50 receive the repeated loads over a long period of time.

Therefore, the clamping force of the connecting bolts 56 and close contact of the connecting lugs 50 with respect to the one end face 8a of the driving pulley 8 are stably retained, and abrasion is not generated in the coating 59 of the connecting lugs 50. This makes it possible to prevent rattle of the outer ring 26 with respect to the driving pulley 8, vibration and noises due to the rattle. Consequently, the power transmission device of the present invention is capable of stably transmitting the power of the engine to the compressor 2 over a long period of time.

The present invention is not limited to the retaining mechanism of the first embodiment, but may be modified in various ways. Retaining mechanisms of second through fourth embodiments will be described below. In the second through fourth embodiments, members and portions identical to those in preceding embodiments will be denoted by the same reference characters, and explanations thereof will be omitted.

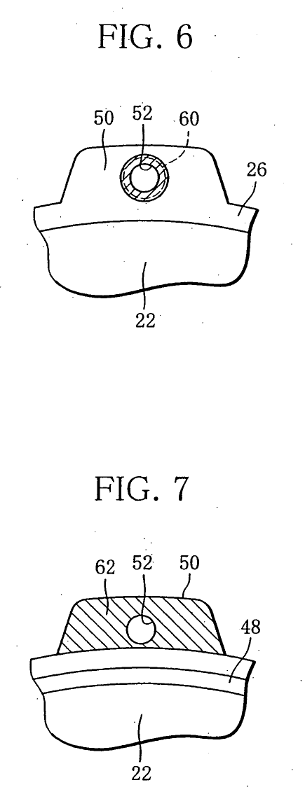

FIGS. 6 and 7 show a retaining mechanism of the second embodiment.

The retaining mechanism of the second embodiment is provided with an outer ring 26 made of a metal material harder than the outer ring of the first embodiment. Even if the outer ring 26 of the second embodiment is applied with the repeated loads over a long period of time, connecting lugs 50 of the outer ring 26 will not be deformed.

In the case of the second embodiment, therefore, the outer ring 26 is not provided with a hardened layer 58 and only has coating 59. More specifically, the outer ring 26 is coated, except for seat portions 60 of the connecting lugs 50, to which the heads of connecting bolts 56 are brought into contact, and whole areas of inner faces 62 of the connecting lugs, which are in close contact with one end face 8a of a driving pulley 8. In FIGS. 6 and 7, non-coated areas of one of the connecting lug 50 are shown by hatching.

In the case of the second embodiment, even if the power transmission device is used for a long term, since the seat portions 60 and the inner faces 62 of the connecting lugs 50 do not have coating itself that never avoid abrasion caused by the repeated loads, the clamping force of the connecting bolts 56 is not reduced by abrasion of the coating.

In the case of the second embodiment, the non-coated areas may be either the seat portions 60 or the inner faces 62.

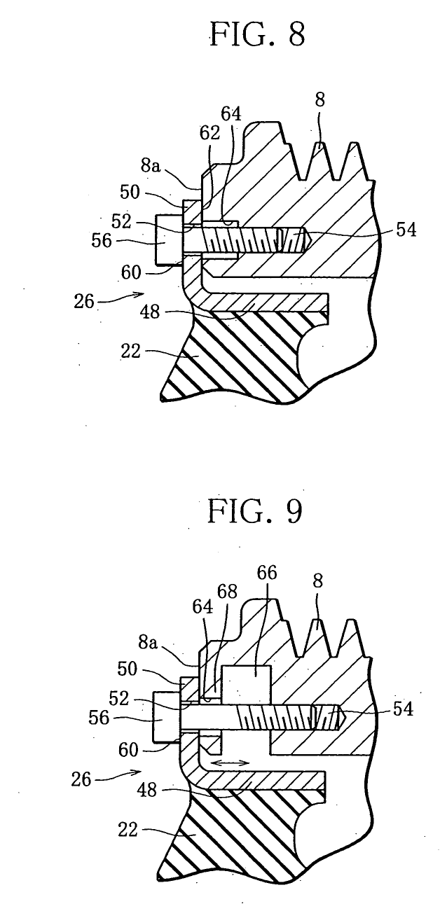

FIG. 8 shows a retaining mechanism of the third embodiment.

In the case of the third embodiment, a driving pulley 8 has clearance holes 64 that open in one end face 8a of the driving pulley 8 and have prescribed depth, and screw holes 54 extends from the bottoms of the clearance holes 64. The screw holes 54 each have a smaller diameter than the clearance holes 64.

As is obvious from FIG. 8, connecting bolts 56 pass through the clearance holes 64 to be screwed in the screw holes 54. There is secured a prescribed gap between the connecting bolt 56 and an inner circumferential surface of the clearance hole 64 over the depth of the clearance hole 64.

When the connecting bolts 56 are screwed, the clearance holes 64 allow the connecting bolts 56 to be elastically deformed in the axis direction of the bolts 56. Therefore, even if applied to the connecting bolts 56 over a long period of time, the repeated loads are absorbed by the connecting bolts 56 that have been elastically deformed.

As a consequence, even if the outer ring 26 of the third embodiment is formed of a rolled steel plate and has coating 59 similarly to the outer ring of the first embodiment, the clamping force of the connecting bolts 56 is stably retained as long as deformation of connecting lugs 50 of the outer ring 26 and/or abrasion of the coating 59 in the connecting lugs 50 is within a range where they are absorbed due to the elastic deformation of the connecting bolts 56.

FIG. 9 shows a retaining mechanism of the fourth embodiment.

In the case of the fourth embodiment, the driving pulley 8 has an annular split groove 66 formed between the clearance holes 64 and the screw holes 54 of the third embodiment. The split groove 66 opens in the inner circumferential surface of the driving pulley 8 and form a portion located between one end face 8a of the driving pulley 8 and the split groove 66 as an annular thin wall 68. The thin wall 68 is allowed to be elastically deformed in an axis direction (arrow direction in FIG. 9) of a driven rotor 12 with the root portion thereof as the center of deformation.

Since the repeated loads are absorbed due to the elastic deformation of the thin wall 68, in the same manner as in the third embodiment, deformation of connecting lugs 50 and/or abrasion of coating 59 in the connecting lugs 50 is prevented, and the clamping force of the connecting bolts 56 is stably retained.

As described, since the clamping force of the connecting bolts 56 is stably retained in either case of the second through fourth embodiments, the power transmission devices of the second through fourth embodiments are capable of satisfactorily transmitting the power of the engine to the compressor 2 without generating vibration and noises in the same manner as in the first embodiment.

The power transmission device of the present invention may include arbitrary combinations of the first through fourth embodiments and can be disposed in various power transmitting paths, in addition to the power transmitting path connecting the engine and the compressor to each other.

1. A power transmission device for transmitting power of a drive source to a drive shaft of a consumption device, the power transmission device comprising:
a ring-shaped driving member for receiving the power from the drive source to be rotated by the received power, said driving member having one end face and a screw hole formed in the one end face;
a cylindrical driven member concentrically arranged in said driving member; for connecting said driving member and the drive shaft of the consumption device to each other, said driven member including an outer circumferential surface, a connecting element protruded from the outer circumferential surface in a radial outward direction of said driven member and superposed upon the one end face of said driving member, the connecting element being made of metal, and a bolt passed through the connecting element to be screwed in the screw hole of said driving member, for connecting the connecting element to the one end face of said driving member; and
a retaining mechanism for retaining a clamping force of the bolt, said mechanism including a treatment portion provided to at least one of the connecting element or said driving member.

2. The device according to claim 1, including a driving pulley disposed in a power transmitting path connecting an engine of a vehicle serving as the drive source and a compressor, as the consumption device, for an air conditioning system of the vehicle, said driving pulley being rotatably supported on a housing of the compressor as said driving member.

3. The device according to claim 2, wherein:
said driven member is a driven rotor having a torque limiter built-in.

4. The device according to claim 3, wherein:
said driven rotor further includes a center disc connected to the drive shaft of the compressor, and a ring-shaped absorptive rubber that encloses the center disc; and
the absorptive rubber has an inner ring engaged with the center disc with the torque limiter intervening therebetween, and an outer ring that forms an outer circumferential surface of said driven rotor and is provided with the connecting element.

5. The device according to claim 4, wherein:
the connecting element includes a plurality of lugs integrally formed in the outer ring; and
the lugs are arranged at regular intervals in a circumferential direction of the outer ring and protrude in a radial outward direction of the outer ring.

6. The device according to claim 5, wherein:
the treatment portion of said retaining mechanism includes a heat treatment layer formed in entire surfaces of the lugs.

7. The device according to claim 6, wherein:
the heat treatment layer is a hardened layer.

8. The device according to claim 7, wherein:
the treatment portion further includes coating covering the hardened layer.

9. The device according to claim 5, wherein:
the treatment portion of said retaining mechanism includes coating provided to the lugs, except for at least a seat portion of the lug with respect to the bolt.

10. The device according to claim 9, wherein:
the lugs each have an inner face in close contact with one end face of said driving pulley and an outer face including the seat portion, and
the coating is formed only in the outer faces of the lugs, except for the seat portions.

11. The device according to claim 5, wherein:
the treatment portion of said retaining mechanism includes a machined portion formed in said driving pulley, for allowing at leas one of the bolt and part of said driving pulley to be elastically deformed in an axis direction of the bolt.

12. The device according to claim 11, wherein:
the machined portion includes a clearance hole opened in the one end face of said driving pulley and connected to the screw hole, the clearance hole having an inner diameter larger than an outer diameter of the bolt.

13. The device according to claim 12, wherein:
the machined portion further includes an annular groove formed in an inner circumferential surface of said driving pulley, the annular groove separating the clearance hole from the screw hole, for forming a thin wall in said driving pulley as said part thereof, the thin wall including the one end face of said driving pulley and being elastically deformable in the axis direction of the bolt.

14. The device according to claim 1, wherein:
the treatment portion of said retaining mechanism includes a heat treatment layer formed in an entire surface of the connecting element.

15. The device according to claim 14, wherein:
the heat treatment layer is a hardened layer.

16. The device according to claim 15, wherein:
the treatment portion further includes coating covering the hardened layer.

17. The device according to claim 1, wherein:
the treatment portion of said retaining mechanism includes coating formed on the connecting element, except for at least a seat portion of the connecting element with respect to the bolt.

18. The device according to claim 17, wherein:
the connecting element has an inner face in close contact with one end face of said driving member and an outer face including the seat portion; and
the coating is formed only in the outer face of the connecting element, except for the seat portion.

19. The device according to claim 1, wherein:
the treatment portion of said retaining mechanism includes a machined portion formed in said driving member, the machined portion allowing at least one of the bolt and part of said driving member to be elastically deformed in an axis direction of the bolt.

20. The device according to claim 19, wherein:
the machined portion includes a clearance hole opened in the one end face of said driving member and connected to the screw hole, the clearance hole having an inner diameter larger than an outer diameter of the bolt.

21. The device according to claim 20, wherein:
the machined portion further includes an annular groove formed in an inner circumferential surface of said driving member, for forming a thin wall in said driving member as said part thereof, the thin wall including the one end face of said driving member and being elastically deformable in the axis direction of the bolt.
